(19) United States
(12) Patent Application Publication
(10) Pub. No.: US 2018/0094786 A1
(43) Pub. Date: Apr. 5, 2018

(54) FOCUSING LENS COUPLED WITH OPTICAL FIBER AND SUNLIGHT RECEIVING DEVICES USING THESE LENSES

(71) Applicant: University of Science, Vietnam National University - Hanoi, Hanoi (VN)

(72) Inventors: Thuat Tran Nguyen, Hanoi (VN); Hieu Chi Hoang, Hanoi (VN); Quan Duc Ho, Hanoi (VN); Quan Quang Nguyen, Hanoi (VN); Hai Hoang Nguyen, Hanoi (VN)

(73) Assignee: University of Science, Vietnam National University - Hanoi, Hanoi (VN)

(21) Appl. No.: 15/730,986

(22) Filed: Oct. 12, 2017

(30) Foreign Application Priority Data
Oct. 28, 2016 (VN) 1-2016-04140

(51) Int. Cl. F21S 11/00; G02B 6/32; G02B 5/20; G02B 5/26; G02B 6/04

(52) U.S. Cl. CPC F21S 11/002; G02B 6/32; G02B 6/04; G02B 5/26; G02B 5/208

(57) ABSTRACT

The invention introduces converging lenses connecting with optical fibers and a device for receiving sunlight that uses these lenses to converge sunlight from every angle of the sun during the day and the collected light beam at the output is quite parallel. To converge light from every angle of the sun, without using any motion part, small lenses are arranged to build a convex surface. Sunlight collected by these lenses become a parallel light beam and are guided by optical fibers. These optical fibers are arranged tightly to build a bundle of optical fibers in order to make it easier to further transmit and to use at the output of the device.

### FIELD OF THE INVENTION

This invention is in the field of energy saving. Specifically, it uses a focusing lens coupled with an optical fiber and a complete device using these lenses to receive and transmit sunlight. These lenses and device are used directly for illuminating or decorating in premises by sunlight.

### BACKGROUND OF THE INVENTION

Nowadays, there are more and more devices that collect sunlight for illumination purpose. These devices meet two main problems when dealing with sunlight: (i) change—the direction of direct sunlight depends on time and on location, (ii) density—solar energy is not high enough for specific applications. In order to solve these two problems, these devices have been designed in a complicated way including many different optical elements and tracking systems.

In the U.S. Pat. No. 4,201,197 called “Solar Energy Collector Having A Fiber-Optic Cable” (Raymond H. Dismer), a sunlight collecting device has two parabolic mirrors and light is guided by an optical cable contains many optical fibers from the collector to points of use. In another U.S. Pat. No. 4,257,401 called “Solar Heat Collector” (Ronald M. Daniels), a Fresnel lens and a plane mirror are used to collect sun energy for heating a liquid tube which leads to a boiler. In the U.S. Pat. No. 4,389,085 called “Lighting System Utilizing The Sunlight” (Kei Mori), the lighting system uses optical fibers for transmitting and scattering sunlight. The sunlight is focused into optical fibers by using lenses and separated optical connectors. The sunlight collector of this system can be controlled by a mechanical system following the direction of the sun. In another U.S. Patent by the same author, U.S. Pat. No. 4,461,278 called “Apparatus For Collecting and Transmitting Solar Energy”; the device uses focusing lenses to converge sunlight into optical fibers. These optical fibers are put at the focal point of these lenses, and the positions of optical fibers are able to be adjusted.

In U.S. Pat. No. 4,534,616 called “Fiber Optic Connector Having Lens” (Terry P. Bowen, Bernard G. Caron, Ronald F. Cooper, Douglas W. Glover—AMP Incorporated), a two optical fiber-connection system is based on the use of a connector having a concave surface and a slot for connecting fiber optics; these two connectors are combined together to connect two optical fibers.

These invention proposed methods to connect two optical fibers but without any detail of connecting lenses and optical fibers, or any detail of converging sunlight into an optical fiber, or the optical connectors are quite complex for every day uses.

### SUMMARY OF THE INVENTION

The purpose of this invention is to propose a method to connect quickly and simply a convex lens with an optical fiber, and a sunlight collection device using these lenses for resolving two main problems of sunlight that all solutions mentioned above could not successfully addressed. This device is able to collect sunlight from all directions without using any tracking system. Sunlight at different directions are converged by different lenses, each lens converges sunlight into one end of an optical fiber. Due to the special structure of the lens's output, sunlight is guided and bent to be parallel before going into optical fibers.

This invention proposes a convex lens connecting with an optical, including:

a lens having a convex surface as the sunlight inlet, a concave surface as sunlight outlet. The convex cross section is bigger than that of the concave. The convex surface is coated with infrared reflection layer to ensure that only visible light is transmitted. The body of the lens is made of transparent material, and its cross-section is reduced from the convex to the concave surface, there is a slot at the end of the concave surface to plug an optical fiber;

an optical fiber, made of a transparent material, whose diameter is as big as that of the lens's outlet slot. The optical fiber is plugged into the slot, and there is a small gap of air between the lens and the optical fiber. Light is converged into the concave surface, and because of the air between the concave surface and the optical fiber, light will become parallel in the air gap before going into the optical fiber.

This invention proposes a method of connecting a positive lens used in light emitting device (LED) bulbs with an optical fiber. This method includes:

a lens used in LED bulbs is made of transparent material. The light receiving surface is plane. Sunlight after going through the light receiving surface or reflecting totally at the side of the lens will come out at a slot in the end of the lens. The outlet surface of the slot is convex;

an optical fiber is plugged into the slot of the lens, and separated with the lens at a distance to create the air gap between them. The diameter of the optical fiber is the same as that of the slot and it is made of same material with the lens. Sunlight going through this air part is converged at a point inside the optical fiber. Light is guided subsequently by the optical fiber to the point of use.

The invention proposes also a light receiving and transmitting device using the above mentioned lenses and optical fibers. Lenses and optical fibers are packaged tightly in a cover. These lenses are arranged to form the convex surface of the device. Optical fibers are packed as a bundle. Sunlight is converged by the lenses, guided by optical fibers to the output. At the output of this device, sunlight is used directly or continues to be guided to the point of use through the tube having the highly reflective inner surface.

According to a prototype of the sunlight receiving and transmitting device described above, the convex surface of the device can be spherical, parabolic, hyperbolic, elliptic or a suitable surface that the light intensity at the output of the optical fiber bundle is constant and independent on the sunlight direction during the day.

According to another prototype of the sunlight receiving and transmitting device described in any term above, the optical fibers are arranged as bundles corresponding with the positions of the lenses at the receiving surface of the device. Or in another prototype, the optical fibers are arranged into bundles that the light intensity at the output of the optical fiber bundles is homogenously distributed.

### BRIEF DESCRIPTION OF THE DRAWINGS

FIG. 1A of the focusing lens used for connecting the optical fiber according to the invention.

FIG. 1B is the cross-section drawing of the focusing lens of FIG. 1A.

FIG. 2A is the respectively drawing of the positive lens connected with the optical fiber according to the invention. The optical fiber connection can be realized quickly. The lens is used for converging sunlight, the optical fiber is used for guiding light to the point of use.

FIG. 2B is the cross-section drawing of the positive lens connected with the optical fiber of FIG. 2A.

FIG. 3 is the cross-section drawing of the positive lens connected with the optical fiber. The lens is used in conventional LED bulbs. The lens is used for converging sunlight, a part of light is guided by the optical fiber and transmitted to the point of use.

FIG. 4A is the perspective drawing of the sunlight receiving and transmitting device using the positive lenses connected optical fibers according to the invention.

FIG. 4B is the cross section drawing of the sunlight receiving and transmitting device of FIG. 4A.

FIG. 5 is the cross-section drawing of the output of the device using the positive lenses connected optical fibers according to the invention.

FIG. 6 is the cross-section drawing of the light convergence part combined with the lenses of the device using the positive lenses connected optical fibers according to the invention.

### DETAILED DESCRIPTION OF THE PREFERED EMBODIMENTS

The invention includes a positive lens coupled with an optical fiber, a method of connecting a conventional LED lens with an optical fiber and a device using these lenses to collect sunlight from all directions without using any tracking system. The purpose of the invention is to use directly sunlight for lighting or decorating. Sunlight is collected from all directions by using the lenses arranged to form a convex surface and the output of each lens is coupled with optical fibers. These optical fibers play a role in guiding sunlight in order to make the light from all direction to be parallel at the output.

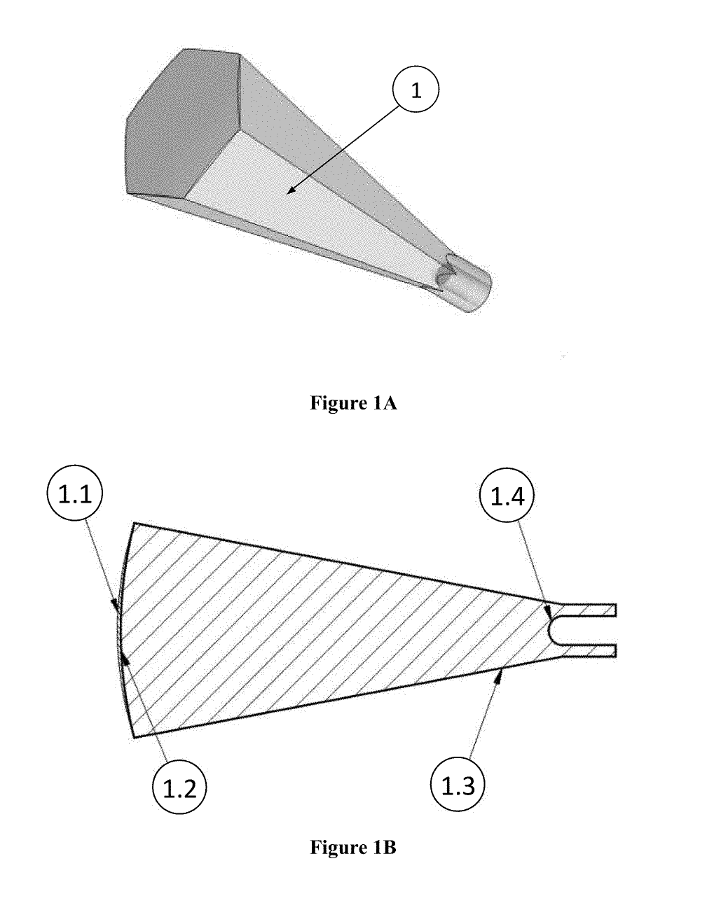

FIG. 1A is the perspective drawing and FIG. 1B is the section drawing of a lens connected with an optical fiber. Sunlight receiving surface is the convex surface 1.2, the output is the concave surface 1.4. The section of the convex surface 1.2 is hexagonal, and the section of the concave surface is circular. The section of the surface 1.2 is larger than that of the surface 1.4. The body of the lens 1.3 is transparent, having a hexagonal cross-section, and is reduced from the beginning (surface 1.2) to the end (surface 1.4). To select light in the visible range into the body of the lens 1.3. The concave surface 1.4 has a slot to connect an optical fiber.

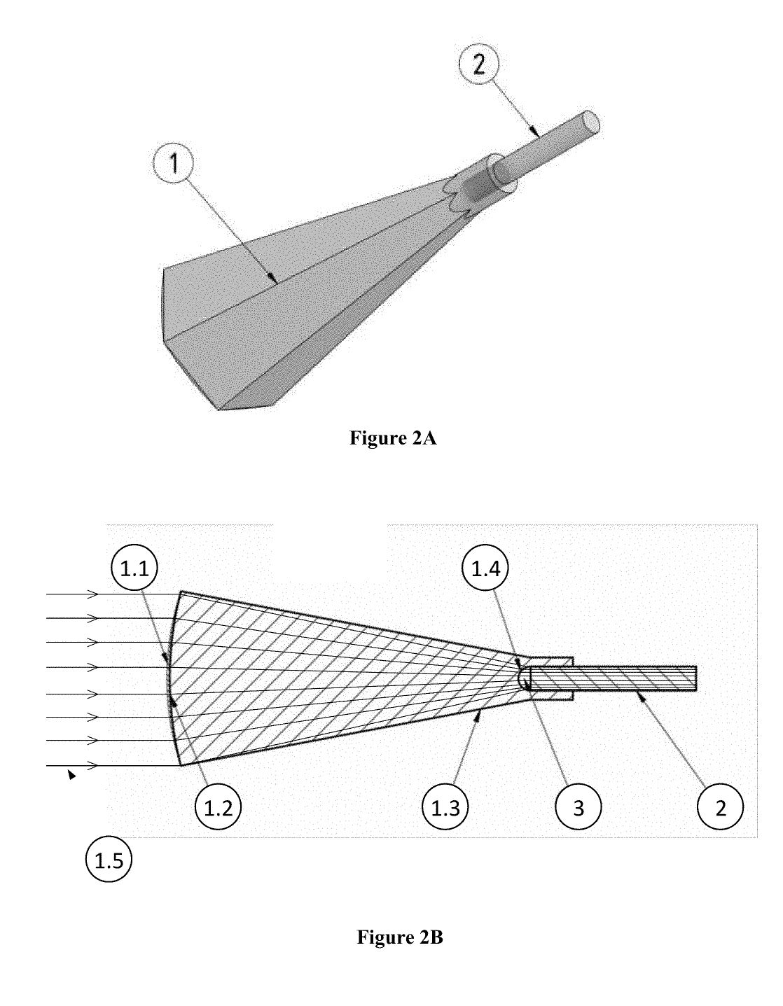

According to FIG. 2A, sunlight from many different directions are converged by the lens 1 made of a transparent material. Light after being converged will be collected, guided by the optical fiber 2 at the output. The positions of the lens 1 and the optical fiber 2 are described on FIG. 2A.

FIG. 2B illustrates the section of the lens connected with the optical fiber. The optical fiber 2 is made of a transparent material, having same diameter with that of the slot in the end of the concave surface 1.4. Therefore sunlight 1.5 arrive to the light receiving surface 1.2 will be converged into the concave surface 1.4. Due to the air gap 3 between the concave surface 1.4 and the optical fiber 2, sunlight going through the concave surface 1.4 is made parallel and transmitted through the optical fiber 2.

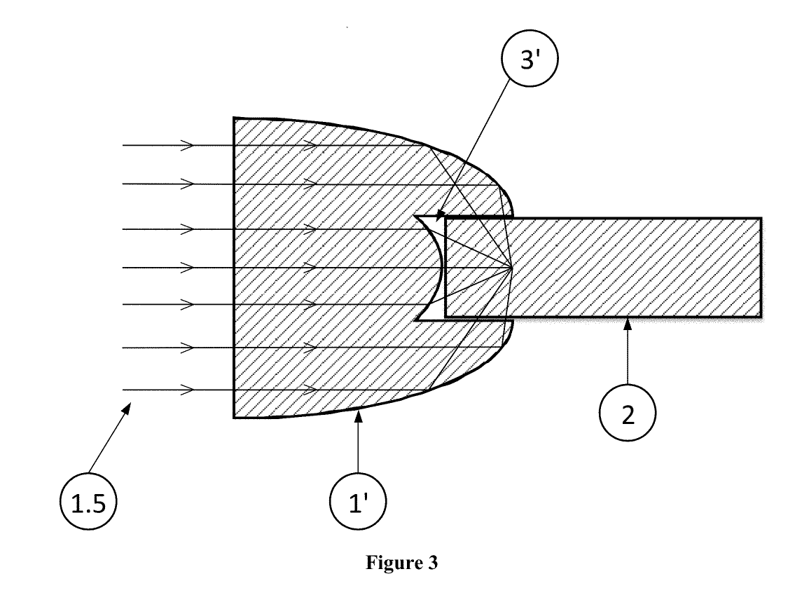

FIG. 3 illustrates the cross section of the positive lens connected with the optical fiber, which is used in LED bulbs. The optical fiber 2 is made of a transparent material, having same diameter with that of the hole in the end of lens 1′. When the optical fiber 2 is connected with the lens 1′, due to the air gap between the optical fiber 2 and lens 1′, one part of sunlight 1.5 is converged into the optical fiber 2, the other part is reflected totally at the side of the lens 1′ and refracted into the optical fiber. The part of sunlight 1.5 at the position near the symmetric axis of the lens 1′ is guided by the optical fiber 2 to the point of use.

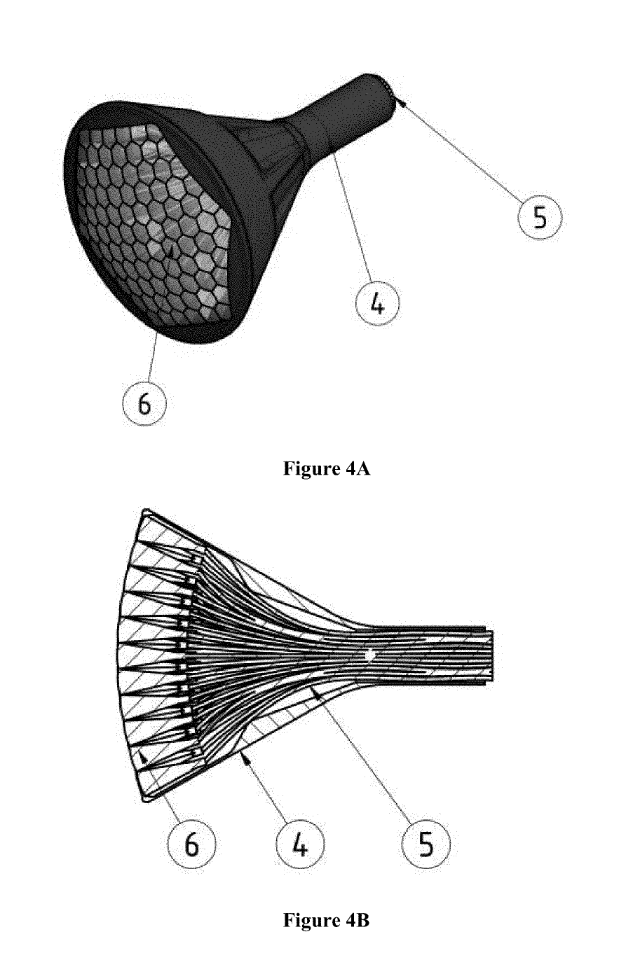

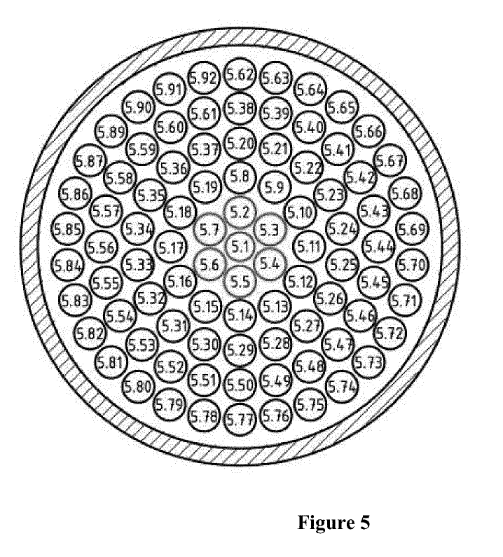

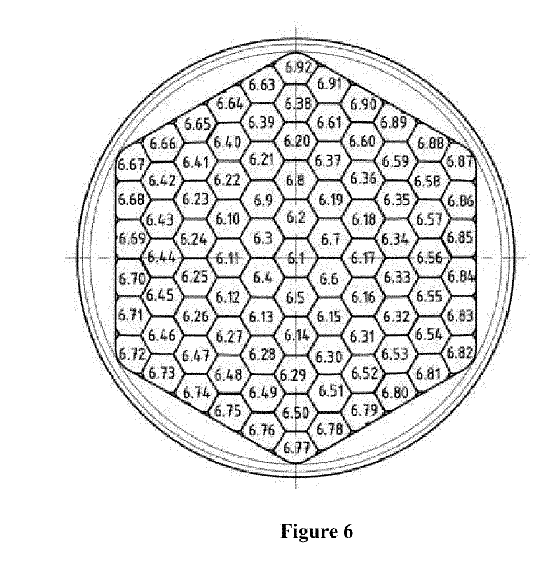

FIG. 4, FIG. 5, and FIG. 6 illustrate the sunlight receiving devices which use lenses 1 and optical fibers 2. The lenses 1 are connected with others to build the spherical surface 6 which has a large aperture. Depending on the purpose that this aperture could be varied from 45° to 145°. With small aperture, the device can only collect sunlight that is perpendicular with the horizontal ground line (at the noon time), and this device can collect sunlight for more hours if the aperture is larger. The optical fibers from the lens numbered from 6.1, 6.2, 6.3 . . . to 6.N, with N is the number of the lens 1 which are used in the sunlight collector device, are gathered to form the bundle 5. Sunlight from many directions are converged by the lens 6.1, 6.2, 6.3 . . . 6.N and transmitted through the optical fibers, numbered from 5.1, 5.2, 5.3 . . . to 5.N to the output of the device. At the output of the device, the collected sunlight will be transmitted to other places by using the tubes whose inner surfaces are highly reflective. All the lenses 6 and the bundle of optical fibers 5 will be packed tightly in the plastic or metal shell 4. The end of the shell 4 could be made in the thread which could be able to connect with other devices for subsequent purposes.

FIG. 6 is a cross-section view of the sunlight receiving part of the device. All the lenses 1 are arranged to be a group of lenses 6 as showed on FIG. 6 with the aperture of the device is larger than 45°. The outside of the group of lenses 6 is shaped to be hexagonal which allows easily gathering and arranging of the lenses 1. FIG. 5 is the cross-section view of the output of the sunlight of the device in which the optical fibers are bundled to be a circular shape. The arrangement of the output of optical fibers bundle 5 is made by arranging the optical fibers 5.1, 5.2, 5.3 . . . 5.N corresponding with the lens 6.1, 6.2, 6.3 . . . 6.N. In this way, the device which is shown by the drawings from FIG. 4A to FIG. 6 can be able to converge sunlight from every direction, to transmit and to make them almost parallel at the output. This device has no moving part, is made of inexpensive materials and is suitable to use sunlight directly for illuminating in premises.

The lenses 1 which are used to build a spherical surface 6 of the device as illustrated by the drawings from FIG. 4A to FIG. 6 could be the lens that used in LED lamps. In most cases, these LED lamp lenses have a circular cross-section, therefore, it requires a suitable frame to create the spherical surface 6. These LED lamp lenses have holes to connect LED lamp, which we can use differently, to connect with optical fibers. However these LED lamp lenses are optimized to illuminate light from the LED lamp, which is the hole, to the lens larger surface. While the light collection device needs to collect sunlight from the lens larger surface into the input of optical fiber (the hole—same position with the LED lamp), so the convergence of the sunlight is not perfectly optimized. Nevertheless, we can use these available lenses in order to reduce the cost of making the light collection devices for easier way to approach the market of these optical devices.

Moreover, the lenses forming the spherical surface 6, as shown by on FIG. 3, can be used to build the convex parabolic, hyperbolic, elliptic surface or the surface that could collect sunlight from every angle of the sun during the day. These convex surfaces could be made by arranging the lenses which have hexagonal cross-section. However, these lenses could have circular, square, triangular, pentagonal cross-section. In addition, the convex or concave surface of the lenses 1 could be spherical, parabolic, hyperbolic or elliptic. With another formation of the light collection device, the lenses which used to create a convex surface could be the same type of lenses or any combination of several kinds of lenses, each lens is corresponded with one kind of cross-section. The convex surface could be made by grafting a group of lenses or a prefabricated mold has slots, one slot contains one lens.

The optical fiber 2 which transmits and changes the direction of sunlight could be replaced by other special optical fiber whose the cross-section of the input is larger than that of the output. Moreover, the arrangement of the optical fibers to build the bundle of fibers 5 could be corresponded to the position of the lenses as the arrangement of the curved surface of the device, or it could be placed freely in such a way that sunlight arriving to the output is equally distributed. The arrangement of the output of the optical fibers is carefully considered so that the sunlight intensity of the output remains the same with every position of the sun in the day. For example, the optical fibers correspond with the lenses at the edge of the curved surface 6 could be placed nearby the center of the bundle of the fibers 5, the optical fibers correspond with lenses in the center are distributed near the edge. As a result, in the case the sun is not at the midday position, sunlight is still guided to the center of the bundle of optical fibers 5. Therefore it is easier to distribute and transmit sunlight from the output of the device.

The lenses which connect with the optical fibers and the light-receiving device of this invention focus on the visible radiation of sunlight thanks to the infrared reflection layer on the surface of the lenses 1. This device could converge the sunlight from every direction of the Sun and have no moving part. As a result, it reduces the cost of device maintenance, simplifies the complexity of work when assembling the device on the roof. This device is very suitable to use sunlight directly for illuminating rooms in premises or for decorative optical fibers light bulbs in large conference or ball rooms.

What is claimed is:

1. A lens connecting with an optical fiber, comprising:
a lens having a convex surface as the sunlight inlet, a concave surface as sunlight outlet. The convex cross section is bigger than that of the concave. The convex surface is coated with infrared reflection layer to ensure that only visible light is transmitted. The body of the lens is made of transparent material, and its cross-section is reduced from the convex to the concave surface, there is a slot at the end of the concave surface to plug an optical fiber; and
an optical fiber, made of a transparent material, whose diameter is as big as that of the lens's outlet slot. The optical fiber is plugged into the slot, and there is a small gap of air between the lens and the optical fiber. Light is converged into the concave surface, and because of the air between the concave surface and the optical fiber, light will become parallel in the air gap before going into the optical fiber.

2. The lens of claim 1 wherein the cross-section of the convex surface could be hexagonal, circular, square, triangular or pentagonal and the convex surface or the concave surface of the lens could be spherical, parabolic, hyperbolic or elliptic.

3. The lens connects of claim 1 wherein the optical fiber has the cross-section of the input larger than that of the output.

4. A method of connecting a positive lens used in light emitting device bulbs with an optical fiber, comprising:
a lens used in LED bulbs is made of transparent material. The light receiving surface is plane. Sunlight after going through the light receiving surface or reflecting totally at the side of the lens will come out at a slot in the end of the lens. The outlet surface of the slot is convex; and
an optical fiber is plugged into the slot of the lens, and separated with the lens at a distance to create the air gap between them. The diameter of the optical fiber is the same as that of the slot and it is made of same material with the lens. Sunlight going through this air part is converged at a point inside the optical fiber. Light is guided subsequently by the optical fiber to the point of use.

5. The device for receiving and changing directions of light uses the lens connected with the optical fiber of claim from 1 to 3 and the method for connecting lenses and optical fibers of claim 4, comprising:
lenses; and
optical fibers are packaged tightly in a cover. These lenses are arranged to form the convex surface of the device. Optical fibers are packed as a bundle. Sunlight is converged by the lenses, guided by optical fibers to the output. At the output of this device, sunlight is used directly or continues to be guided to the point of use through the tube having the highly reflective inner surface.

6. The device of claim 5 wherein the convex surface is spherical, parabolic, hyperbolic, elliptic or the surface that could collect sunlight from every angle of the sun during the day.

7. The device of claims 5 and 6 wherein the lenses forming the convex surface have hexagonal, circular, square, triangular, pentagonal cross-section or they are any combination of these different cross-section for forming the convex surface.

8. The device of claim from 5 to 7 wherein the bundle of optical fibers with positions are corresponded to the positions of the lenses forming the convex light receiving surface of the device.

9. The device of claim from 5 to 7 wherein the positions of optical fibers in the bundle are mixed in a way that sunlight intensity of the output of the device remains the same with every position of the sun in the day.
